(19) United States
(12) Patent Application Publication
(10) Pub. No.: US 2006/0226643 A1
(43) Pub. Date: Oct. 12, 2006

(54) Gas bag module for a vehicle occupant restraint device

(75) Inventor: Thomas Britz, Bessenbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/394,870

(22) Filed: Mar. 31, 2006

(30) Foreign Application Priority Data
Apr. 6, 2005 (DE) 20 2005 005 372.4

(51) Int. Cl. B60R 21/239

(52) U.S. Cl. 280/739

(57) ABSTRACT

A gas bag module for a vehicle occupant restraint device has a gas generator for inflating a gas bag and at least one device for creating a discharge opening in the gas bag module, through which gas produced by the gas generator can be discharged from the module. The device for creating the discharge opening has at least one conductive circuit, which at least in part contacts a wall of the module, in which the discharge opening is to be produced. The conductive circuit includes at least two different conductive materials, and at least one contact point of two conductive materials is arranged such that, after an ignition of the gas generator, it is exposed to a different temperature than a rest of the contact points, so as to generate a current in the conductive circuit, which results in a heating of the conductive circuit and a weakening of the wall along the conductive circuit.

### TECHNICAL FIELD

The invention relates to a gas bag module for a vehicle occupant restraint device.

### BACKGROUND OF THE INVENTION

Conventionally, in a gas bag module of a vehicle occupant restraint system, the gas bag is designed to be inflated as rapidly as possible with the gas produced by a gas generator. In certain cases, it is certainly desirable not to inflate the gas bag with the entire available gas volume, or, more generally, to discharge gas, for which reason discharge openings (possibly in addition to a permanently open vent) are provided in the gas bag module, which when released make it possible to limit the pressure in the gas bag.

The literature has many different approaches to releasing these discharge openings during the inflation process of the gas bag as a function of the specific load conditions, or with a specific time delay after the ignition of the gas generator. Among other ways, it is known to melt or to burn away one part of the gas bag using electrical current or to insert a less stable part in the gas bag, which acts as a preset breaking point in response to the impingement of the hot gas produced by the gas generator. WO 01/15942 A1 discloses a gas bag that has a slide fastener that is sealed by a fuse wire, it being possible to melt the fuse wire using a control unit.

In DE 102 21 659 A1, a gas bag is disclosed in whose fabric a metal wire is inserted, which burns through, creating an opening, when a current flows through the wire. From the same laid-open print, a gas bag is known that has a through opening that is covered by a second material, the melting point of the second material being lower than the temperature of the impinging gas.

In the technical approaches hitherto known, which attempt to create an (additional) discharge opening using a current-carrying conductor, the current in each case must be made available by applying an external voltage source. On the other hand, approaches that seek to exploit the pressure or the high temperature of the gases produced by the gas generator for releasing an (additional) discharge opening require increased expense in manufacturing the gas bag module because one part of the module must be made of a weaker material that is designed to fail—as desired—in response to the impingement of the gas. However, if the decision is to be made as a function of the load conditions, whether the discharge opening is to be released or whether it is to remain closed, this approach (especially if the material to be ruptured is a part of the gas bag) requires very great technical expense because the weak point would then have to be protected from stresses.

The present invention provides a gas bag module having a device for creating a discharge opening, which distinguishes itself by a simple design without an external voltage source, and which is reliably released.

### BRIEF SUMMARY OF THE INVENTION

This is achieved in a gas bag module for a vehicle occupant restraint device having a gas generator for inflating a gas bag and at least one device for creating a discharge opening in the gas bag module, through which gas produced by the gas generator can be discharged from the module. The device for creating the discharge opening has at least one conductive circuit, which at least in part contacts a wall of the module, in which the discharge opening is to be produced. The conductive circuit includes at least two different conductive materials, and at least one contact point of two conductive materials is arranged such that, after an ignition of the gas generator, it is exposed to a different temperature than a rest of the contact points, so as to generate a current in the conductive circuit, which results in a heating of the conductive circuit and a weakening of the wall along the conductive circuit. The invention makes use of the fact that, in a conductive circuit that is composed of at least two different conductive materials, a thermoelectric DC voltage arises if one contact point of two conductive materials has a different temperature than the other contact point(s) (Seebeck effect). This thermoelectric voltage creates a thermoelectric current, which is used to create the discharge opening, a purpose that the interior pressure within the gas bag module can also serve. In this manner, it is possible to do without an external voltage source, thus making possible a simple design that also excels by its low weight.

The conductive materials may be metals or metal alloys. In this context, the choice of the pair of materials from which the conductive circuit is formed has an influence on the time delay in the creation of the discharge opening, because the associated thermal electromotive force is a material variable.

Preferably, the conductive materials are wires, which it is particularly simple to bring into contact with the wall.

One of the contact points is preferably arranged in the immediate vicinity of the gas generator. This “hot” contact point can be attached, e.g., directly to the gas generator, to any cage that may be arranged around the gas generator, or to a flange that is located on the gas generator. In this way, the energy of the gas generator is used to heat the contact point.

The other contact point is preferably fixed on a rigid component of the gas bag module at a distance from the gas generator. For example, the rigid component (“rigid” in the meaning of “inflexible”) can be a side wall of a generator support, a housing of the module, or a covering cap. In any case, provision is made for a stable attachment of the contact point. Depending on where in the vicinity of the gas generator the “hot” contact point is positioned and where the other, “cold” contact point is located, it is possible to set varying temperature differentials between the two contact points, i.e., varying magnitudes of thermoelectric currents flow. In this way, it is possible in a controlled manner to influence the time that elapses before the creation of the discharge opening.

Preferably, a section of the conductive circuit is connected to the wall, thus assuring a permanent, secure contact.

According to a preferred embodiment, the wall in an area where it is contacted by the conductive circuit has a material that is different from the material of the rest of the wall. For example, the material in the area of the contact can be specifically predamaged, or it can have a reduced thickness. Similarly, it is possible to use a diaphragm or foil that is made of another material and that is less robust than the conventional wall material.

The device for creating the discharge opening can also have a plurality of conductive circuits, which contact the wall within a limited area. These conductive circuits are arranged on the wall, e.g., in pairs at right angles to each other, so that a larger opening is created in the rupture than would be obtained if the wall were only ruptured along one single conductive track.

If the conductive circuit has a switch, it is possible to suppress the creation of the discharge opening under certain load conditions. For example, the switch can be opened by a mass sensor that is located in the vehicle seat in the event that a very heavy person occupies the seat and it is necessary to provide a relatively hard gas bag that furnishes a high degree of restraining action.

According to a preferred embodiment, the wall is a wall of the gas bag. In this case, it is comparatively simple to produce a discharge opening using the current-carrying conductor. The conductive material can be woven into the gas bag fabric, it can be glued to the fabric, or it can be sewn into it. Alternatively, it is of course also possible for the wall in which the discharge opening is created to be, for example, a wall of the generator support.

The gas bag wall in the area of the discharge opening can have a foil diaphragm that is contacted by the conductive circuit. The diaphragm is distinguished by its having less robustness than the conventional gas bag fabric.

The current that is generated is preferably so great that the wall is at least partially melted. In this way, the creation of the discharge opening is assured.

### BRIEF DESCRIPTION OF THE DRAWINGS

FIG. 1 schematically depicts a sectional view of a gas bag module according to the present invention; and

FIG. 2 depicts a detail of a gas bag module according to a second embodiment of the present invention.

### DETAILED DESCRIPTION OF THE PREFERRED EMBODIMENTS

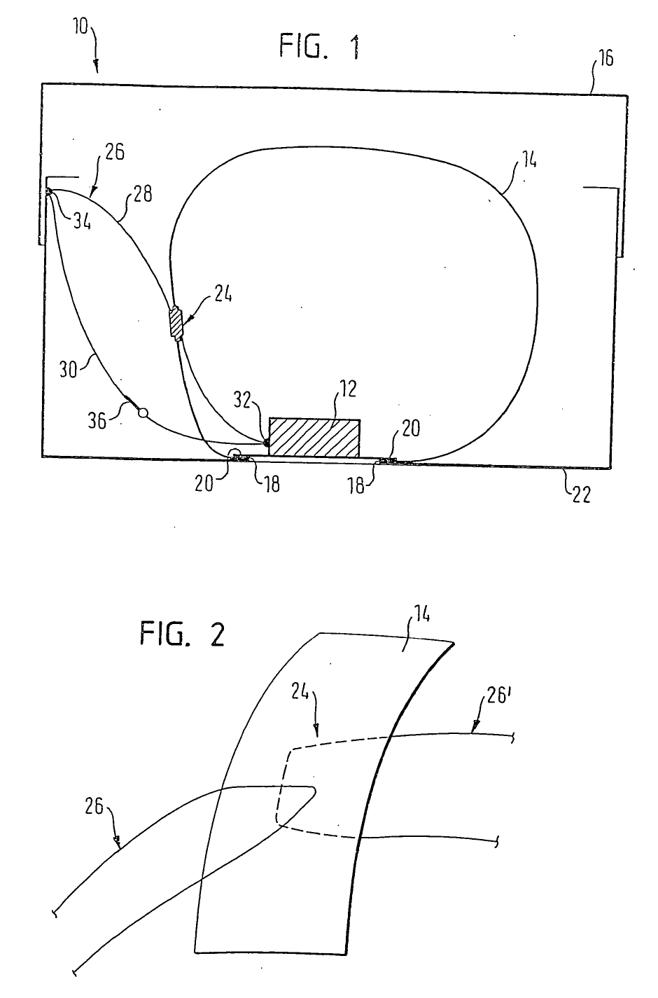

FIG. 1 shows a gas bag module 10, which is intended especially for use as a driver-side gas bag module, although it is not limited thereto. Gas bag module 10 has a gas generator 12 and a gas bag 14 that is schematically depicted in the Figure, and in the undeployed state, as shown, is bordered by a covering cap 16 that is facing the vehicle occupant. Gas bag 14 has an inflation opening 18, which is fixed in position at a generator support 22 by a holding ring 20 that is arranged around gas generator 12.

Gas bag 14 in the area of a wall 24 is connected to a conductive circuit 26, which includes two different conductive materials in the form of different metal wires 28, 30. A first contact point 32 of the two metal wires 28, 30 is attached directly to gas generator 12, whereas a second contact point 34 is fixed on a side wall of generator support 22. Conductive circuit 26 also has a switch 36, which is usually closed. Conductive circuit 26 is connected to wall 24 of gas bag 14, in that metal wire 28 can be woven into the gas bag fabric, which is made up of synthetic fibers, e.g., polyamide, it can be glued to the fabric, or it can be sewn into it.

In the installed state (FIG. 1) both contact points 32, 34 have the same temperature. No current flows in conductive circuit 26. However, when gas generator 12 is ignited, first contact point 32, which is located in the immediate vicinity of gas generator 12, is acted upon by a much higher temperature than second contact point 34, which is located at a distance. Due to the temperature differential between contact points 32, 34, an electrical current flows (assuming switch 36 is closed). The current flow causes the fibers to melt in the area of gas bag wall 24, which is connected to conductive circuit 26, and in this way it creates an (additional) discharge opening in gas bag 14. This process is supported by the fact that the interior pressure within gas bag 14 is raised due to the generated gases.

To make the rupturing easier, the gas bag fabric in the area of wall 24 can be predamaged in a controlled manner, or it can have a lower fabric thickness. Alternatively, at this location of wall 24 it is possible to include in gas bag 14 another material, e.g., a diaphragm or an aluminum foil, which is less robust than the conventional gas bag fabric.

Finally, in a further embodiment that is shown in FIG. 2, it is possible to attach to the gas bag fabric several of the above-described conductive circuits 26 and 26′, e.g., in pairs at right angles to each other. In this context, first conductive circuit 26 is mounted on the exterior side of gas bag wall 24, whereas second conductive circuit 26′ contacts the interior side of gas bag 14. In this way, upon rupturing, a larger opening is created than would be obtained if the fabric of gas bag 14 ruptured only along one single conductive circuit.

In gas bag module 10 according to the present invention, it is in principle also possible, within certain limits, to use the design to adjust the time delay with which the discharge opening is created after the ignition of gas generator 12. Depending on where in the vicinity of gas generator 12 the “hot,” first contact point 32 is positioned, it is possible to set different levels of temperature differentials between the two contact points 32, 34, i.e., thermoelectric currents of varying magnitudes flow, and the time lapse before the creation of the opening is of varying magnitudes. In addition, the choice of the material pair from which conductive circuit 26 or 26′ is formed exerts an influence on the time delay, because the associated thermal electromotive force is a material variable.

In addition, under certain load conditions, the rupture can be suppressed by simply activating switch 36. The latter can be opened by a mass sensor that is located in the vehicle seat, for example, even before a potential accident, in the event that a very heavy person occupies the seat and it is necessary to provide a relatively hard gas bag 14 that furnishes a greater degree of restraining action.

1. A gas bag module for a vehicle occupant restraint device, said gas bag module having a gas generator (12) for inflating a gas bag (14) and
at least one device for creating a discharge opening in said gas bag module (10), through which gas produced by said gas generator (12) can be discharged from said module (10),
said device for creating said discharge opening comprising at least one conductive circuit (26, 26′), which at least in part contacts a wall of said module (10), in which said discharge opening is to be produced,
said conductive circuit (26, 26′) including at least two different conductive materials, and at least one contact point (32) of two conductive materials being arranged such that, after an ignition of said gas generator (12), it is exposed to a different temperature than a rest of the contact points (34), so as to generate a current in said conductive circuit (26, 26′), which results in a heating of said conductive circuit (26, 26′) and a weakening of said wall along said conductive circuit (26, 26′).

2. The gas bag module as recited in claim 1, wherein said conductive materials are one of metals and metal alloys.

3. The gas bag module as recited in claim 1, wherein said conductive materials are wires (28, 30).

4. The gas bag module as recited in claim 1, wherein one of said contact points (32) is arranged in an immediate vicinity of said gas generator (12).

5. The gas bag module as recited in claim 4, wherein said other contact point (34) is fixed on a rigid component of said gas bag module (10) at a distance from said gas generator (12).

6. The gas bag module as recited in claim 1, wherein a section of said conductive circuit (26, 26′) is connected to said wall.

7. The gas bag module as recited in claim 1, wherein said wall in an area where it is contacted by said conductive circuit (26, 26′) comprises a material that is different from the material of a rest of said wall.

8. The gas bag module as recited in claim 1, wherein said device for creating said discharge opening comprises a plurality of conductive circuits (26, 26′), which contact said wall within a limited area.

9. The gas bag module as recited in claim 1, wherein said conductive circuit (26, 26′) comprises a switch (36).

10. The gas bag module as recited in claim 1, wherein said wall is a wall (24) of said gas bag.

11. The gas bag module as recited in claim 10, wherein said gas bag wall (24) in an area of said discharge opening comprises a foil diaphragm that is contacted by said conductive circuit (26, 26′).

12. The gas bag module as recited in claim 1, wherein said current generated is so great that said wall is at least partially melted.
